(19) United States
(12) Patent Application Publication
(10) Pub. No.: US 2010/0036611 A1
(43) Pub. Date: Feb. 11, 2010

(54) TELEMATICS DEVICE AND METHOD FOR UPLOADING AND DOWNLOADING PERSONAL CAR DRIVE INFORMATION FILE

(76) Inventor: Siyun YOO, Pyeongtaek-si (KR)

Correspondence Address: BIRCH STEWART KOLASCH & BIRCH, PO BOX 747, FALLS CHURCH, VA, 22040-0747, US

(21) Appl. No.: 12/423,253

(22) Filed: Apr. 14, 2009

(30) Foreign Application Priority Data
Aug. 8, 2008 (KR) 10-2008-0077838

(51) Int. Cl. G01C 21/00; G06F 17/30

(52) U.S. Cl. 701/213; 701/200; 701/207; 707/3; 707/E17.108; 707/E17.018

(57) ABSTRACT

A method of controlling a navigation apparatus placed in a vehicle, and which includes acquiring actual drive information about the vehicle driving along a preset travel route to a target location, acquiring additional information about conditions related to the vehicle driving to the target location, and creating a personal car drive information file including the acquired actual drive information and the additional information.

This non-provisional application claims priority under 35 U.S.C. § 119(a) to Patent Application No. 10-2008-0077838 filed in the Republic of Korea on Aug. 8, 2008 the entire contents of which are hereby incorporated by reference.

### BACKGROUND OF THE INVENTION

1. Field of the Invention

The present application relates to a telematics device having a navigation function using a GPS (global positioning system) and a wireless communication function and a method for uploading and downloading a personal car drive information file.

2. Description of the Related Art

Telematics corresponds to a combination of telecommunication and informatics. For example, telematics combines wireless communication with GPS to provide a variety of mobile communication services such as car position information, road condition information, weather information, games, financial information, reservations, shopping and so forth.

As shown in FIG. 1, a telematics device may be mounted in a vehicle such as a car, and performs a navigation operation by displaying a travel route to a target place to which the driver of the car wants to reach after calculating a current position by receiving a GPS signal transmitted from a satellite 200. In addition, the telematics device interfaces with a telematics service provider server (TSP) 400 to receive various information such as road condition information, weather information and so forth. However, the information exchanged between the telematics terminal and the server 400 is very limited.

### SUMMARY OF THE INVENTION

Accordingly, an object of the present invention is to address the above-noted and other problems.

Another object of the present invention is to provide a novel navigation apparatus and corresponding method that allows a user to create and/or view a personal car drive information file including real and updated actual drive information about the vehicle driving along a preset travel route.

To achieve these and other advantages and in accordance with the purpose of the present invention, as embodied and broadly described herein, the present invention provides in one aspect a method of controlling a navigation apparatus placed in a vehicle. The method includes acquiring actual drive information about the vehicle driving along a preset travel route to a target location, acquiring additional information about conditions related to the vehicle driving to the target location, and creating a personal car drive information file including the acquired actual drive information and the additional information.

In another aspect, the present invention provides a navigation apparatus including a display unit configured to display traveling information for a vehicle including the navigation apparatus, a global position system (GPS) unit configured to communicate with at least one satellite and to receive positional information corresponding to the vehicle, and a control unit configured to acquiring actual drive information about the vehicle driving along a preset travel route to a target location, to acquire additional information about conditions related to the vehicle driving to the target location, and to create a personal car drive information file including the acquired actual drive information and the additional information.

Further scope of applicability of the present invention will become apparent from the detailed description given hereinafter. However, it should be understood that the detailed description and specific examples, while indicating preferred embodiments of the invention, are given by illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings, which are given by illustration only, and thus are not limitative of the present invention, and wherein:

FIG. 1 is an overview illustrating an example of a general telematics device;

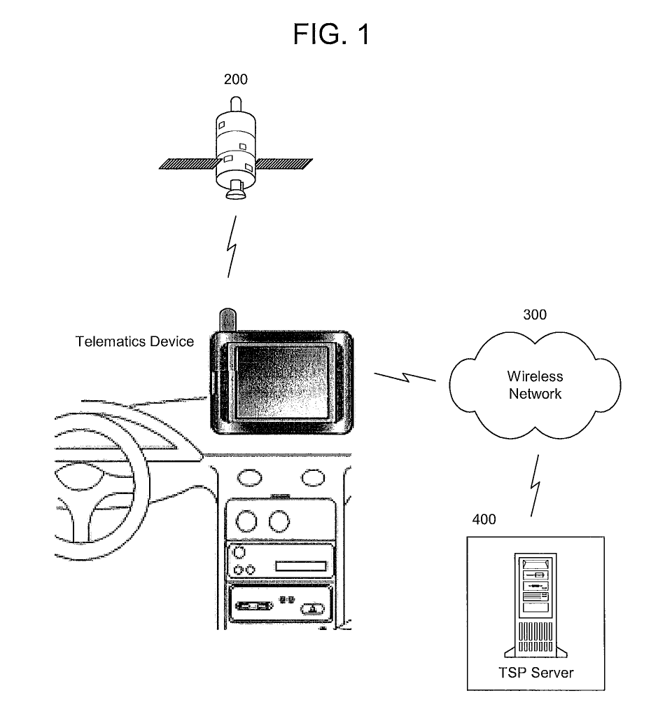

FIG. 2 is a block diagram illustrating a telematics device according to an embodiment of the present invention;

FIG. 3 is a flow chart illustrating a method for uploading a personal car drive information file in the telematics device according to an embodiment of the present invention;

FIGS. 4 and 5 are overviews of display screens illustrating a process of an embodiment for creating a personal car drive information file according to an embodiment of the present invention;

FIG. 6 is an personal car drive information file created according to an embodiment of the present invention;

FIG. 7 is a flow chart illustrating a method for downloading a personal car drive information file in the telematics service provider server according to an embodiment of the present invention;

FIG. 8 is an overview of a display screen displaying a personal car drive information file list according to an embodiment of the present invention; and

FIG. 9 is an overview of a display screen illustrating a personal car travel route downloaded to the telematics device according to an embodiment of the present invention.

### DETAILED DESCRIPTION OF THE INVENTION

Hereinafter, exemplary embodiments of a telematics device and method for uploading and downloading a personal car drive information file according to the present invention will be described in detail with reference to the attached drawings.

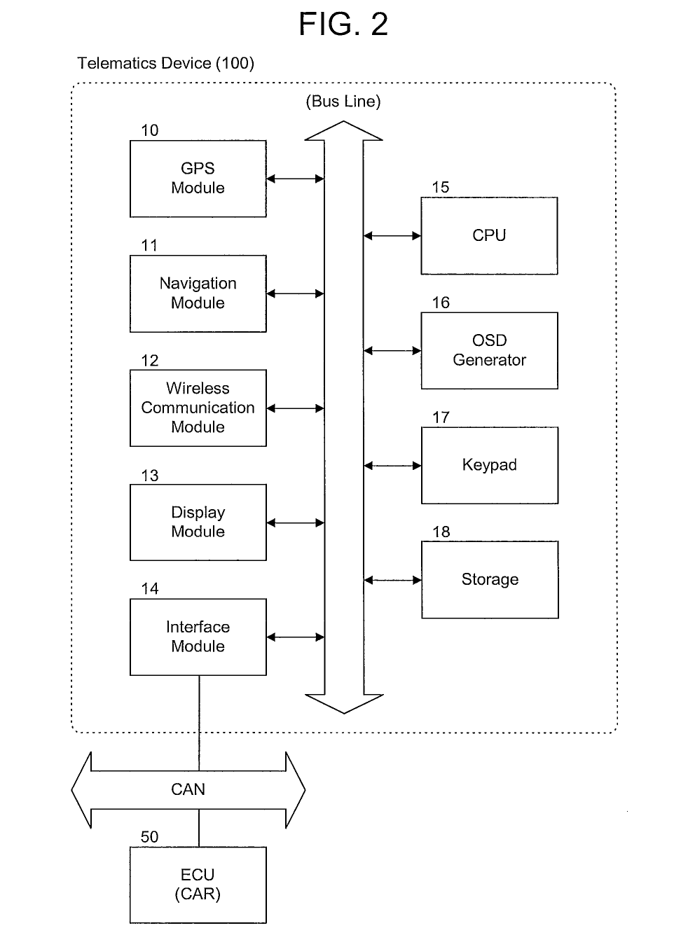

FIG. 2 is a block diagram illustrating a telematics device 100 including, for example, a GPS module 10, a navigation module 11, a wireless communication module 12, a display module 13, an interface module 14, a CPU 15, an OSD (on screen display) generator 16, a keypad 17, and a storage 18. Further, the GPS module 10 receives a GPS signal transmitted from a satellite 200 to calculate a current position, and the navigation module 11 searches, for example, for a route from the current position to one a target place the driver wants to reach and then reads out a corresponding map image.

The display module 13 then displays various menu images generated from the OSD generator 16 along with the map image, and the interface module 14 performs, for example, an interface operation with an electronic control unit (ECU) 50 connected and accessed through a CAN (control area network) within the car. The wireless communication module 12 receives various additional information such as road condition and weather information provided by the telematics service provider server 400, and sends a message indicative of a car status information or the like.

Further, the CPU 15 creates a personal car drive information (PCDI) file according to the driver's request. For example, the CPU 15 acquires actual car drive information about driving to a target place and additional information to create a personal car drive information file, and uploads and transmits the information to the telematics service provider server 400 through a wireless communication network. In addition, the telematics service provider server 400 stores and manages the uploaded personal car drive information file in a database, and transmits and downloads the personal car drive information file to a plurality of other telematics devices so that the personal driver can share an efficient car travel route and drive information that the driver has actually driven, and a variety of additional information such as road condition or weather information with other drivers more conveniently.

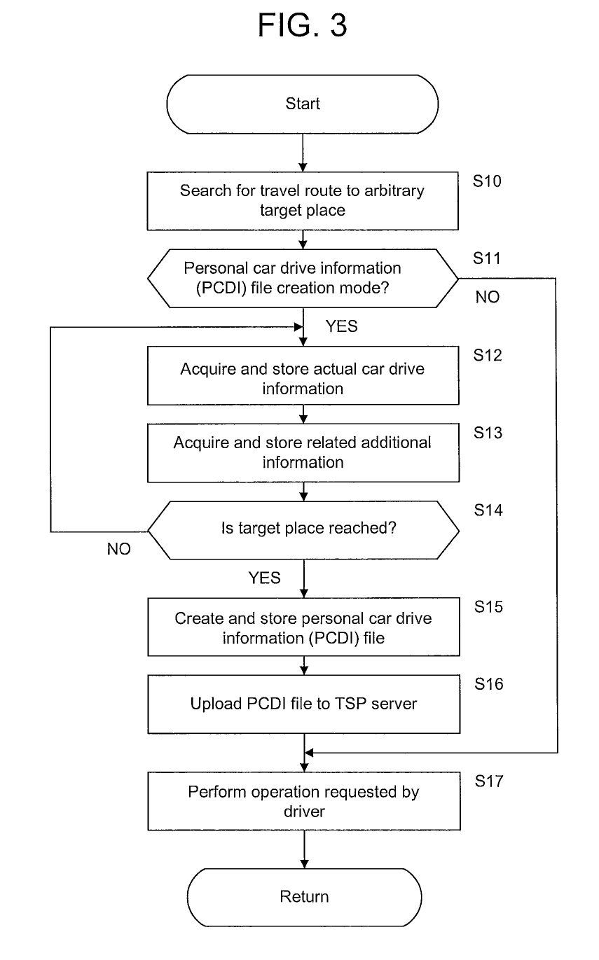

Next, FIG. 3 is a flow chart illustrating a method for uploading a personal car drive information file in the telematics device 100 according to an embodiment of the present invention. FIG. 2 will also be referred to throughout this description. As shown in FIG. 3, the CPU 15 searches for a car travel route to a target place set by the user by operatively controlling the GPS module 10 and the navigation module 11 (S10), and then displays the information on the display module 13. Further, if the user or driver requests a personal car drive information (PCDI) file creation mode (Yes in S11), the CPU 15 acquires a travel route and a travel velocity corresponding to the car and stores this information as actual car drive information in the storage (S12).

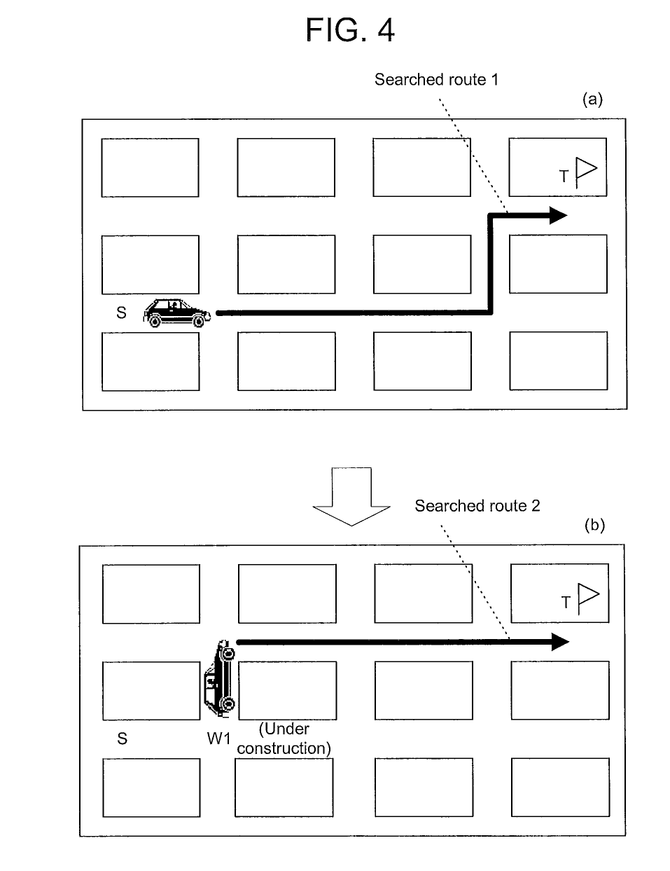

In addition, the CPU 15 acquires various additional information relating to the actual car drive information, and stores the additional information in the storage 18 (S113). For example, as shown in FIG. 4(a), a travel route to a specific target place T is searched and displayed by a navigation operation, and the current position at that time is recognized as a starting place S. Moreover, coordinate values (Xs, Ys) and time (e.g., 07:30) corresponding to the starting place S are stored as actual car drive information, and information input by the driver (e.g., the commuting time on Tuesday) or traffic information or the like provided from the telematics service provider server 400 is received and stored as additional information in the storage 18.

In addition, if the driver arbitrarily specifies a first intermediate place while driving the car, or as shown in FIG. 4(b), if the driver arbitrarily deviates from the travel route searched by a navigation operation, the current position at that time is recognized as the first intermediate place W1. Next, the position coordinate values (Xw1, Yw1) and time (e.g., 07:32) corresponding to the first intermediate place W1 and the travel distance (e.g., 1.0 Km), travel velocity (e.g., 30 Km/hr), etc. from the starting place S to the first intermediate place W1 are stored as actual car drive information, and information input by the driver or traffic information (e.g., construction), weather information or the like provided from the telematics service provider server 400 is stored as additional information.

For instance, the driver can select certain desired information among the variety of information such as traffic information or weather information provided from the telematics service provider server 400, and store the selected information as additional information. In addition, if the driver arbitrarily specifies a second intermediate place while driving the car, or as shown in FIG. 5(a), if the driver arbitrarily deviates again from the travel route searched again by a navigation operation, the current position at that time is recognized as the second intermediate place W2.

Next, the position coordinate values (Xw2, Yw2) and time (e.g., 07:36) corresponding to the second intermediate place W2 and the travel distance (e.g., 4.1 Km), travel velocity (e.g., 61 Km/Hr), etc. from the first intermediate place W1 to the second intermediate place W2 are stored as actual car drive information, and information input by the driver or traffic information (e.g., a traffic jam section) or the like provided from the telematics service provider server 400 is stored as additional information.

In addition, when the target place is reached (Yes in S14) and as shown in FIG. 5(b), the CPU 15 recognizes the current position at that time as the target place T, and then stores the position coordinate values (Xt, Yt) and time (e.g., 07:58) corresponding to the target place T and the travel distance (e.g., 3.9 Km), travel velocity (e.g., 59 Km/Hr), etc. from the previous final intermediate place to the target place T as actual car drive information. Further, traffic information provided by the telematics service provider server 400 is stored as additional information, and the actual total travel distance, average velocity, weather, etc. are stored as additional information. Also, a personal car drive information (PCDI) file is created by associating the stored actual car drive information and additional information with each other, and then the associated information is stored in the storage 18 (S15).

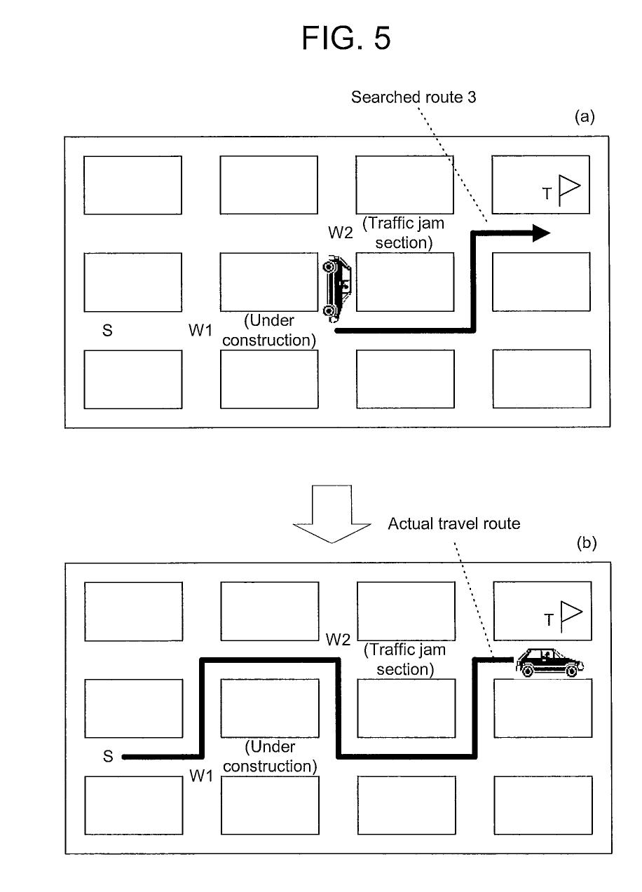

For instance, as shown in FIG. 6, the actual car drive information containing position, travel distance, velocity, and time with respect to a starting place, intermediate places W1, W2, . . . , and a target place, and the additional information containing weather, road condition, and user input information with respect to a starting place, intermediate places, and a target place are stored in association with each other.

In addition, once the personal car drive information file is created, the CPU 15 transmits and uploads the personal car drive information file to the telematics service provider server 400 through a wireless communication network (S16). The upload operation may be automatically performed, or selectively performed according to the driver's request. Afterwards, another or arbitrary operation requested by the driver can be performed (S17).

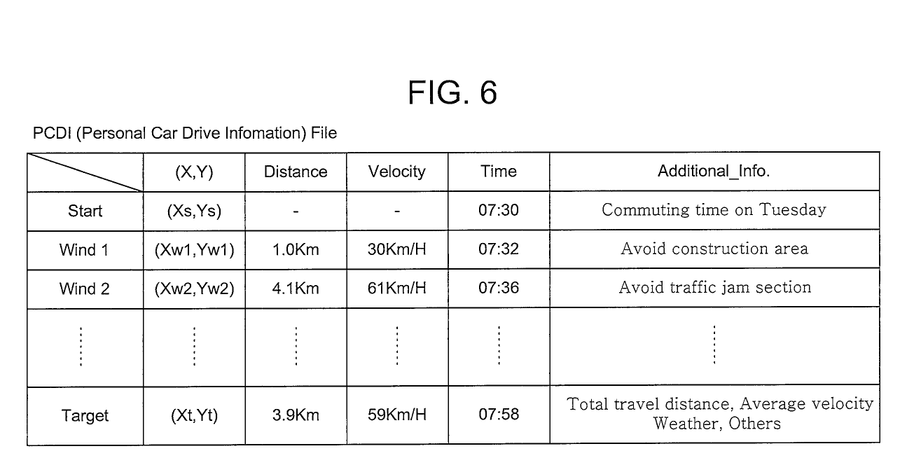

Next, FIG. 7 is a flow chart illustrating a method for downloading a personal car drive information file in the telematics service provider server 400 according to an embodiment of the present invention. As shown, the telematics service provider server 400 receives a personal car drive information file uploaded from the telematics device 100 through a wireless communication network and manages the uploaded file in a database (S30).

Then, based on a request from the telematics device 100 connected and accessed through the wireless communication network, if the user requests a personal car drive information (PCDI) file search mode (Yes in S31), the telematics service provider server 400 performs a two-way communication with the telematics device 100 to demand and receive a search condition (S32). In addition, the search condition received from the telematics device 100 is checked, and then the database is searched to determine whether or not any personal car drive information files matching the search condition exit (S33). If no information files exists (No in S33), the server 400 transmits a guidance message indicative of the non-existence of the corresponding file to the corresponding terminal 100 (S34).

However, if an information file exists (Yes in S33), any corresponding personal car drive information files are searched, and then a file list is created and transmitted to the corresponding terminal 100 (S35). For example, when the starting place and target place received as the search condition are consistent with two spots among the starting places, intermediate places, and target places contained in the personal car drive information files stored and managed in the database, a file list about the corresponding personal car drive information files is created, and transmitted to the telematics device 100.

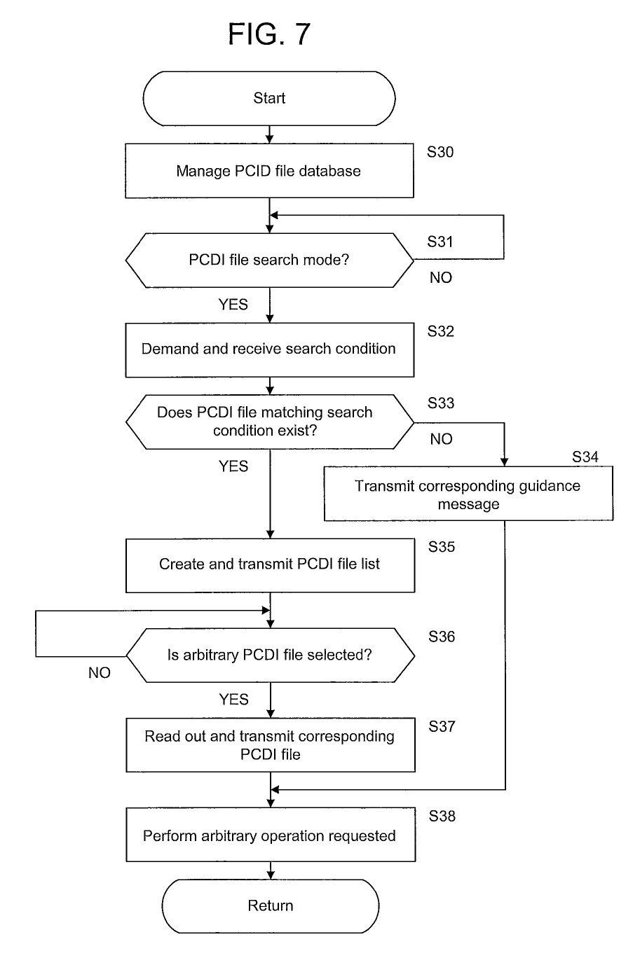

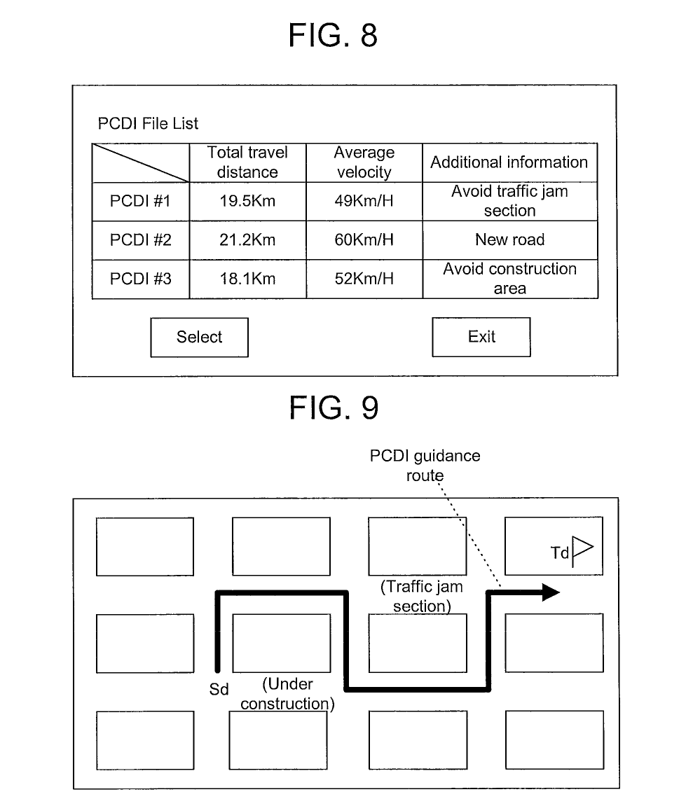

For example, FIG. 8 is an overview of a display screen on the telematics device 100 displaying such information. As shown, the total travel distance, average velocity, and additional information of a plurality of personal car drive information files PCDI #1˜3 are displayed. In addition, as shown in FIG. 9, if the positions of the starting place Sd and target place Td received as the search condition are consistent with the positions of the first intermediate place W1 and target place T as stated with reference to FIG. 5, only car drive information and additional information about driving to the target place Td=T from the first intermediate place W1 corresponding to the starting place SD are selected and provided, thereby preventing substantially unnecessary information from being inefficiently sent and received.

Moreover, as shown in FIG. 7, when one arbitrary personal car drive information file is selected (Yes in S36), the telematics service provider server 400 reads out the corresponding personal car drive information file to perform a series of download operations for transmitting the corresponding information file to the telematics device (S37), and then performs any other operation requested by the user or driver (S38). Therefore, an efficient car travel route and drive information, by which the personal drive actually has driven, and a variety of additional information can be shared with other drivers more conveniently.

Also, when a driver who has been driving along a travel route to a specific target place displayed by the navigation operation of the telematics device drives the car along an arbitrary more efficient travel route, the information corresponding to the new travel route is advantageously shared with corresponding actual car drive information and additional information with other drivers more conveniently.

Although the exemplary embodiments of the present invention described above have been disclosed for illustrative purposes, various modifications, variations, substitutions or additions thereto are possible, without departing from the scope and spirit of the invention disclosed in the accompanying claims.

What is claimed is:

1. A method of controlling a navigation apparatus placed in a vehicle, the method comprising:
acquiring actual drive information about the vehicle driving along a preset travel route to a target location;
acquiring additional information about conditions related to the vehicle driving to the target location; and
creating a personal car drive information file including the acquired actual drive information and the additional information.

2. The method of claim 1, wherein the actual car drive information includes at least one of a position of the vehicle, a distance the vehicle has traveled, a speed of the vehicle, and an amount of time the vehicle has traveled.

3. The method of claim 2, wherein the additional information includes at least one of a weather condition around the vehicle, a road condition of a road driven on by the vehicle, and user input information.

4. The method of claim 3, wherein the actual car drive information and the additional information is acquired for a starting location of the vehicle, at least one intermediate location between the starting and target location, and the target location.

5. The method of claim 4, further comprising:
determining when the vehicle has deviated from the preset travel route; and
setting an intermediate location between the starting location and the target location at a point that the vehicle has deviated from the preset travel route.

6. The method of claim 4, further comprising:
receiving an input from the driver that the vehicle has or will deviate from the preset travel route; and
setting an intermediate location between the starting location and the target location at a point that the vehicle has or will deviate from the preset travel route.

7. The method of claim 1, further comprising:
uploading the created personal car drive information file to a telematics service provider server through a wireless communication network either automatically when the vehicle reaches the target location or based on a received user signal requesting the personal car drive information file be uploaded to the telematics service provider server.

8. The method of claim 7, further comprising:
receiving a search condition for searching personal car drive information files uploaded to the telematics service provider server;
searching a database on the telematics service provider server for personal car drive information files having information matching the received search condition; and
displaying the search drive information files having the information matching the received search condition on a display of the navigation apparatus.

9. The method of claim 8, further comprising:
receiving a selection signal indicating a selection of one of the displayed search drive information files; and
displaying the selected search drive information file on the display of the navigation apparatus.

10. The method of claim 9, wherein the displaying step only displays information included in the selected search drive information file that matches a current position of the vehicle to the target position.

11. A navigation apparatus, comprising:
a display unit configured to display traveling information for a vehicle including the navigation apparatus;
a global position system (GPS) unit configured to communicate with at least one satellite and to receive positional information corresponding to the vehicle; and
a control unit configured to acquiring actual drive information about the vehicle driving along a preset travel route to a target location, to acquire additional information about conditions related to the vehicle driving to the target location, and to create a personal car drive information file including the acquired actual drive information and the additional information.

12. The navigation apparatus of claim 11, wherein the actual car drive information includes at least one of a position of the vehicle, a distance the vehicle has traveled, a speed of the vehicle, and an amount of time the vehicle has traveled.

13. The navigation apparatus of claim 12, wherein the additional information includes at least one of a weather condition around the vehicle, a road condition of a road driven on by the vehicle, and user input information.

14. The navigation apparatus of claim 13, wherein the actual car drive information and the additional information is acquired for a starting location of the vehicle, at least one intermediate location between the starting and target location, and the target location.

15. The navigation apparatus of claim 14, wherein the control unit is further configured to determine when the vehicle has deviated from the preset travel route, and to set an intermediate location between the starting location and the target location at a point that the vehicle has deviated from the preset travel route.

16. The navigation apparatus of claim 14, further comprising:
an input unit configured to receive an input from the driver that the vehicle has or will deviate from the preset travel route,
wherein the control unit is further configured to set an intermediate location between the starting location and the target location at a point that the vehicle has or will deviate from the preset travel route.

17. The navigation apparatus of claim 11, further comprising:
a wireless communication unit configured to upload the created personal car drive information file to a telematics service provider server through a wireless communication network either automatically when the vehicle reaches the target location or based on a received user signal requesting the personal car drive information file be uploaded to the telematics service provider server.

18. The navigation apparatus of claim 17, further comprising:
an input unit configured to receive a search condition for searching personal car drive information files uploaded to the telematics service provider server,
wherein the control unit is further configured to request the telematics service provider server to search a database on the telematics service provider server for personal car drive information files having information matching the received search condition, and to control the display unit to display the search drive information files having the information matching the received search condition on a display of the navigation apparatus.

19. The navigation apparatus of claim 18, wherein the input unit is further configured to receive a selection signal indicating a selection of one of the displayed search drive information files, and
wherein the control unit is further configured to control the display unit to display the selected search drive information file on the display of the navigation apparatus.

20. The navigation apparatus of claim 19, wherein the control unit is further configured to control the display unit to only display information included in the selected search drive information file that matches a current position of the vehicle to the target position.
